(19) United States
(12) Patent Application Publication
(10) Pub. No.: US 2014/0130642 A1
(43) Pub. Date: May 15, 2014

(54) Anatomically Configured Razor

(71) Applicant: Milly Rodriguez, Queens, NY (US)

(72) Inventor: Milly Rodriguez, Queens, NY (US)

(21) Appl. No.: 14/073,319

(22) Filed: Nov. 6, 2013

Related U.S. Application Data
(63) Continuation-in-part of application No. 13/373,013, filed on Nov. 2, 2011, now abandoned.

(51) Int. Cl. B26B 19/14

(52) U.S. Cl. CPC B26B 19/148
USPC 83/13; 30/42

(57) ABSTRACT

An electric rotary razor anatomically configured for shaving the gluteal cleft, a delicate private part of a person's anatomy. The razor includes a small, narrow cutter head having one or more rotary cutting systems mounted so that the cutting surface is generally parallel to the length of the device to enable the cutter head to be positioned within and shave this specific region of the body. The razor comprises a handle, a cylindrical elongated neck, and a cutter head mounted to the neck that includes a cutting system having multiple cutting elements. The cutter head is permanent, the rotary cutting systems are disposable, and the neck may be permanent or detachable from the handle for interchange, thereby enabling the device to be safely and hygienically used on different persons.

### BACKGROUND

1. Field of Use

The present invention relates to an electric rotary razor, anatomically configured to shave hair while positioned in the gluteal cleft. The present disclosure relates to features that are particular to shaving this region of the body.

Many people desire to shave hair from the inner buttock region of one's anatomy. However, because of the narrow space in which such hair is located, and the curvature and contours associated with such regions, it is difficult to shave this unwanted hair with existing razor technology. The problem associated with shaving narrow and curved body regions and recesses is that it is difficult to achieve adequate and safe contact between a cutting surface and the body surface to be shaved. For example, with a manual razor, the linear cutting edge of the razor blade cannot be effective unless brought into contact with the relevant body surface, which is difficult to achieve when shaving narrow, curved body regions. There is also an elevated risk of nicking or cutting these sensitive body regions when a manual razor is used, as small and inadvertent tilts and movements of the handle can produce serious skin nicks and cuts. Similarly, for electric razors, the size, shape and position of the cutting head makes it difficult to shave this region. For these reasons, it would be desirable to provide an electric razor that can easily, safely, and effectively remove hair from this region of a person's anatomy without the risk of cutting the skin.

The present invention is directed to an electric rotary razor adapted and configured to shave a narrow region of the body, such as the gluteal cleft. The invention is preferably directed to a battery-operated electric rotary razor that may be re-charged and reused as needed. Further, the electric rotary razor may utilize interchangeable necks, with different cutter head configurations having a different number of rotary cutting systems, to accommodate different people and body sizes.

The present invention is also directed to an electric rotary razor that enables a professional user, such as a physician or a hygienist, to remove unwanted hair from narrow, concave regions of the body in connection with medical procedures, for prevention of infection, or for cosmetic purposes. The invention is further directed to an electric rotary razor that utilizes interchangeable and disposable components, such that the device could be safely and hygienically be used in a commercial setting on different clients or patients.

The present disclosure relates to features that are particular to shaving of the gluteal cleft, though not in a limiting manner. As understood by one skilled in the art, the principles of an electric rotary razor are not restricted to the shaving of a specific part of the body, and may apply to any skin surface. The motor, power supply and other related components are not, per se, part of the present inventive concept, and are individually common and well-known in the art.

2. The Related Prior Art

U.S. Pat. No. 5,208,982 relates to a razor device for shaving concave areas including a standard flat edge razor blade. This patent describes a blade bent into an arc where the blade sharpened edge is mounted on a cylindrical or conical surface in a convex shape. In one embodiment, the lead-in surface is a spherical segment with grooves to guide hairs, and the blade edge is mounted projecting slightly over a slot located at the intersection between the cylindrical and the spherical surfaces. Such curved blade systems have, however, given rise to difficulties with engineering, production, cost, and complexity in use.

U.S. Pat. No. 6,530,151 discloses another straight edge razor blade shaving device. This patent discloses a shaving article for sensitive surfaces and curved body areas which includes an elongate handle having one free end, and an opposite end from which a shank or neck portion defining an aggregate effective lever arm. The article includes a shaving head assembly transversely dependent from the neck portion, the assembly having a blade housing, including means for holding and positioning the blade.

The size and shape of the cutting element on the foregoing prior art references, and on existing commercial shavers, is too big and ill-configured for the desired application. Further, the dimensions of known shavers are unsuitable to reach and shave these body regions in a safe and efficient way. Accordingly, there is a need to provide a shaving system that addresses the disadvantages of current electric and manual razors. The present invention fulfills this need, by providing an electric rotary razor that is easy to control and is configured to fit within and effectively shave sensitive areas of the body, while minimizing the risk of injury to those areas.

### SUMMARY

The present invention provides an electric rotary razor configured to shave a difficult to reach, narrow region of the body, such as the gluteal cleft. The present invention is configured as an electric rotary razor having a handle and a neck containing a cutter head with one or more cutting systems, each including a series of cutting elements (blades) which may be rotated to cut hair. The cutting systems are positioned adjacent to each other so that, when the neck is attached to the handle, the cutting systems are aligned along an axis that runs generally parallel to the length of the device. The handle contains a motor to drive the cutting elements in the rotary cutting system(s).

The electric rotary razor of the present invention has a handle, an elongate slim neck, and a cutter head positioned towards one end of the neck. The portion of the neck between the cutter head and the handle is narrower in cross section than the cutter head and the handle. The handle contains the electrical and drive components, such as batteries and a motor. The slim design of the neck, the alignment of the cutter head, and arrangement of the cutting system and elements, makes it easy to position the rotary cutting system into, through and around the narrow regions of the body to be shaved, and enables shaving despite the curves and contours associated with this region. The present invention provides a razor device that provides a close shave, with less skin irritation and little risk of nicks and cuts to this region, compared to existing manual and electric razors. Thus, the user can comfortably reach and safely shave this region. Further, the present invention is can be used for either wet or dry use when shaving.

The razor of the present invention further includes a neck that is either permanent or detachable from the handle, and includes a permanent cutter head formed therein. The permanent cutter head contains the disposable cutting system, including the cutting elements. This configuration enables a user to replace the cutting system, and permit selection of a neck and cutter head of a particular cutting system configuration suitable for a particular user's body.

The present invention may include a disposable neck, having a permanent cutter head including one or more disposable cutting systems. This can be designed for re-use by a single person, or as a disposable, single use device. As such, the invention may be used by physicians and other medical personnel for hair removal in connection with laser hair removal procedures, or for other medical or cosmetic procedures. The cutter head may provide for different configurations, such as a cutter head with one cutting system or a cutter head with two or more cutting systems. Thus, a medical facility having a single handle could safely reuse the handle with multiple patients, and can select and interchange the appropriate disposable neck for each given patient. In other words, a physician could select a disposable neck with a cutter head with a particular number of cutting systems, suitable for a particular region to be shaved, suitable for the characteristics of the patient's skin, hair type and region size.

### BRIEF DESCRIPTION OF THE DRAWINGS

The above and other objects and advantages of the invention will be apparent upon consideration of the following detailed description, taken in conjunction with the accompanying figures, in which like reference characters refer to like parts throughout, and in which:

FIG. 1 depicts an assembled embodiment of the present invention;

FIG. 2 depicts an alternative assembled embodiment of the present invention;

FIGS. 3A, 3B and 3C depict components of an embodiment of the present invention including a handle (FIG. 3A), a detachable neck with a permanent cutter head and a single disposable rotary cutting system (FIG. 3B), and a detachable neck with a permanent cutter head and two disposable rotary cutting systems (FIG. 3C);

FIG. 4 shows an exploded view of the cutter head and neck of one embodiment of the invention, including select internal components;

FIG. 5 shows an exploded view of the cutter head and neck of another embodiment of the invention, including select internal components.

FIG. 6 shows a view of the handle according to one embodiment of the invention.

FIG. 7 shows another embodiment of the invention.

FIG. 8 depicts an exploded view of another embodiment of the present invention;

FIG. 9 shows an alternative embodiment of the device having two rotary cutting systems and a narrow elongated neck and handle.

### DETAILED DESCRIPTION OF THE PREFERRED EMBODIMENTS

One mode for carrying out the invention is presented in terms of its preferred embodiment. However, the invention is not limited to the described embodiment and a person skilled in the art will appreciate that many other embodiments of the invention are possible without deviating from the basic concept of the invention, and that any such work around will also fall under the scope of this invention. It is envisioned that other styles and configurations of the present invention can be easily incorporated into the teachings of the present invention, and only certain particular configurations are shown and described for purposes of clarity and disclosure and not by way of limitation of scope. The definitions provided herein provide descriptive guidance to one of ordinary skill, but do not place limitations upon the reasonable scope of the meaning of claim terms.

Headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The terms “a” and “an” herein do not denote a limitation of quantity, but rather denote the presence of at least one of the referenced items.

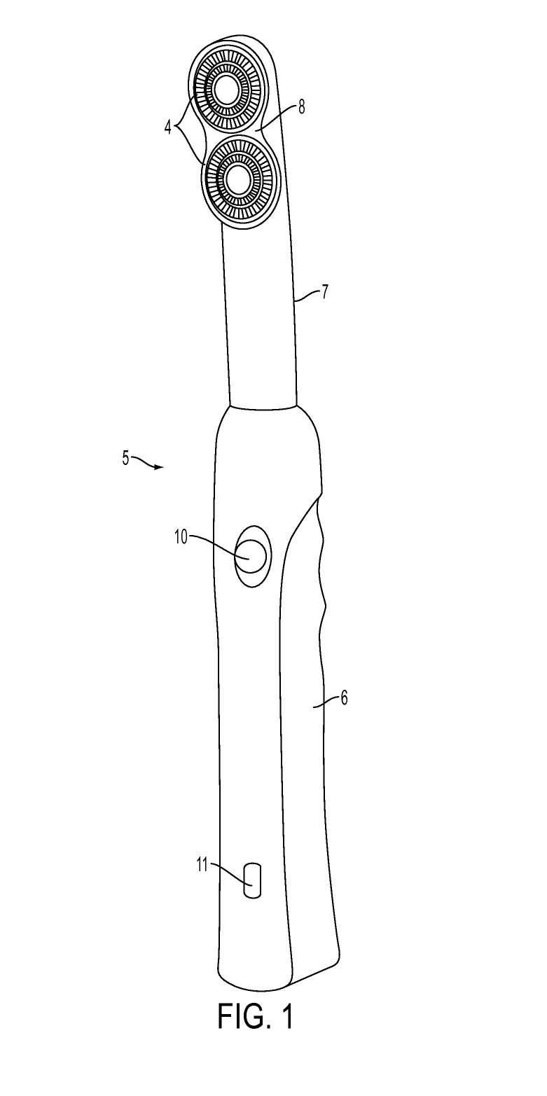

FIG. 1 shows a fully assembled electric rotary razor 5 with a handle 6 and a neck 7. The embodiment depicted in FIG. 1 includes two disposable rotary cutting systems 4. The disposable rotary cutting systems 4 are positioned in a cutter head 8. The two disposable rotary cutting systems are positioned side-by-side and form an axis that runs generally parallel to the length of the device. The two disposable rotary cutting systems each include a series of cutting elements or blades that are rotated to cut hair, as is known in the art. The cutting blades are positioned so that they rotate about an axis that is generally orthogonal to the length of the device.

The neck 7, with disposable rotary cutting systems 4, may be permanent or removable from the handle 6, so that the user can replace the neck with a different neck having a different cutter head configuration. Further, cutter head 8 is permanent, but includes a cutting system that can be removed for cleaning or replacement. The diameter of the neck 7 is designed to be less than that of the diameter of the handle 6, and less than the diameter of the cutter head 8, to further aid in device manipulation and use.

The razor has a power switch 10, such as an on/off switch, and a battery indicator 11. Non-limiting illustrative examples of drive mechanisms for transferring rotational force from the motor to the rotary cutting devices can be found in U.S. Pat. Nos. 6,721,986 and 7,266,855 which are incorporated herein by reference.

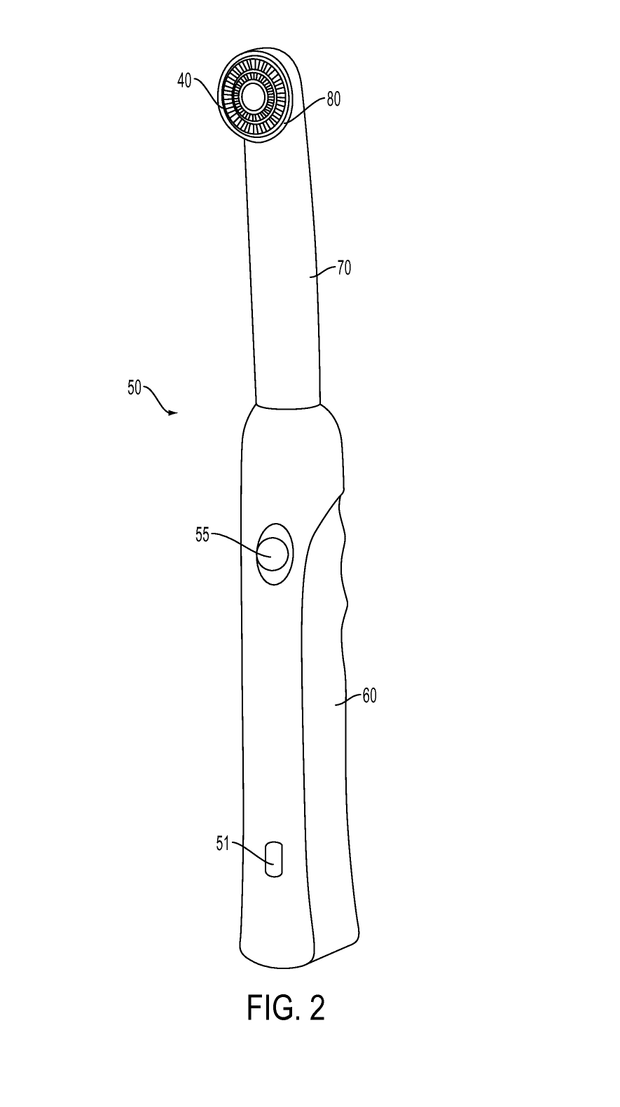

As shown in the alternative embodiment of FIG. 2, the fully assembled electric rotary razor 50 may be configured with the handle 60 having mounted on one end thereof a permanent or detachable neck 70 including a permanent cutter head 80 and a single disposable rotary cutting system 40. The permanent cutter head and disposable cutting system in this configuration are also positioned so that the cutting surface is generally orthogonal to the length of the device. The embodiment shown in FIG. 2 also includes power switch 55 and a battery indicator 51.

In the preferred embodiment, the permanent cutter head and disposable rotary cutting system are positioned by one end of the neck, along the length of the device, and not on the top end of the neck. This is in contrast to the arrangement of conventional devices in which the cutting assembly is positioned on the top end of the device, with the plane of the cutting surface perpendicular to the length of the device. By positioning the cutting system so that it forms a plane generally parallel to the length of the device, the configuration of the present invention enables the cutting region to have a low profile, meaning that the cutting region can be readily positioned and moved within a narrow space or channel, such as the gluteal cleft.

The neck and the handle of the embodiments shown in FIGS. 1 and 2 are configured to be permanent or detachably connected together with each other. If detachably connected, the neck may be added and removed through mechanical fastening means. For example, the neck may be attached to the handle via a clip-on latch mechanism, a screw mechanism, or a bayonet mechanism.

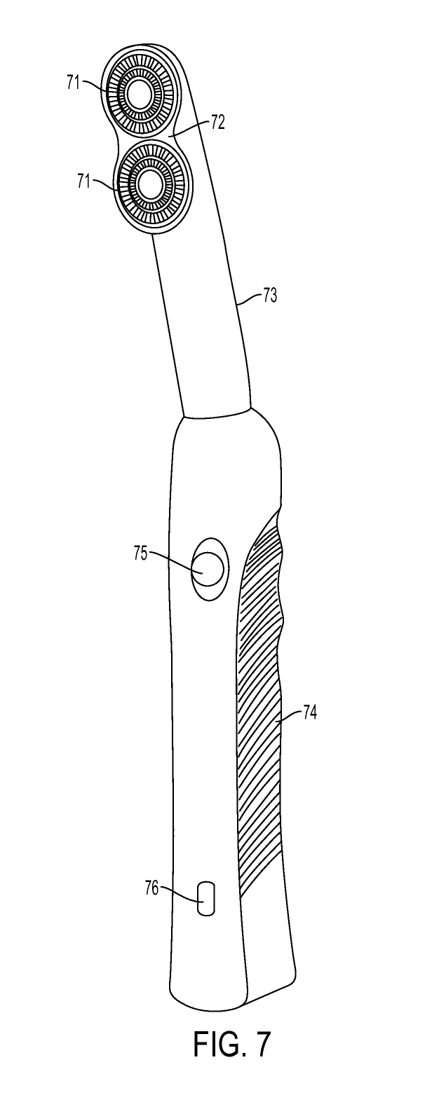

The neck and handle may be attached to form a vertical device having a straight axis. In the alternative, the neck and handle could be attached to one another at an angle of up to 30 degrees from vertical (180°) alignment, as depicted in FIG. 7. Most preferably, the handle and neck form an angle of no more than 15 degrees from vertical (180°) alignment. This angle may enable the user to apply additional pressure to the cutting surface during use, further ensuring proper cutting of hair. The neck could also be curved, allowing greater user flexibility in matching the natural curves of the body as the device is used.

The electric rotary razor 5 is preferably battery operated. It can also include a battery indicator 11 as shown in the figures. It may also include an on/off switch 10, such as a sliding switch. The motor and the batteries are preferably located in the handle 6 of the electric rotary razor 5. The power source may also be configured as non-rechargeable batteries secured in a battery compartment accessible from outside the device. The battery compartment could be adapted to allow batteries to be replaced, such as a lid covering the battery compartment, secured by screws. The batteries could also be positioned in a replaceable compartment which forms part of the handle, but is detachable therefrom. The device may also be adapted to be connected to an AC power source. The present invention can further include a compact rechargeable stand for recharging the battery in the handle.

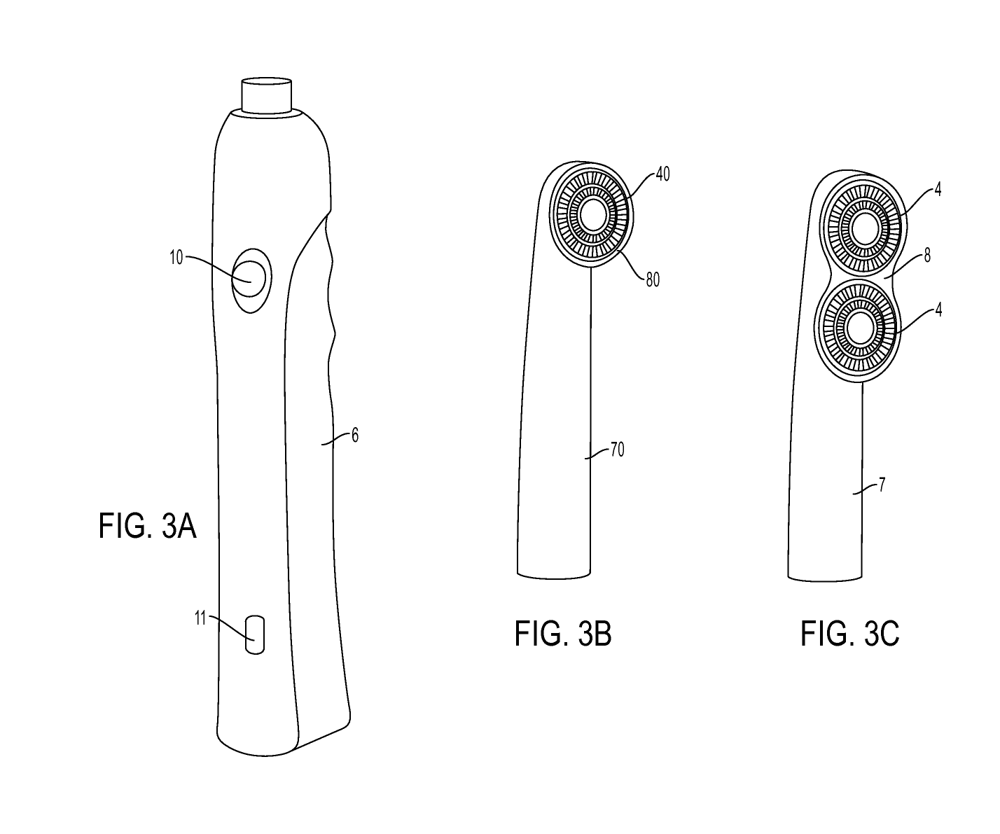

FIGS. 3A-C show replaceable, interchangeable necks 7, 70 of the invention along with handle 6. The replaceable neck aspect of the invention makes possible the use of the same handle 6 with different necks 7, 70. The interchangeable necks can be provided of different angles of attachment. For use in commercial settings or at medical facilities, staff can be trained to select a neck and cutter head appropriate for a given person or procedure. The neck can also be designed as a disposable, single use component, such that a sterile neck can be used with each patient, while the handle may be re-used with multiple patients.

FIG. 3B shows a detached neck 70, and a permanent cutter head 80 with one disposable rotary cutting system 40. FIG. 3C shows a detached neck 7, and a permanent cutter head 8 with two disposable rotary cutting systems 4. The disposable rotary cutting systems 4 are removable for replacement, as described below.

In the preferred embodiment, the handle is about 16.5 cm (6.5 inches) long and about 2.5-3.8 cm (1-1.5 inches) in diameter. The handle may be studded or curved or otherwise fashioned to form a better surface for the user to grip. The handle may also be customized with a stylized grip, made of, for example, rubber or a thermoplastic resin.

The rotary cutting system preferably includes a plurality of cutting surfaces, made of stainless steel or a ceramic material, or any other suitable materials commonly used in the art to cut hair smoothly. The dimensions of the cutter head may be varied. In one embodiment, a cutter head with two rotary cutting systems is about 2.2 inches (5.6 cm) in length, and about 1.2 inches (3.0 cm) in width. The neck where the cutter head is located has a depth of less than about 1 inch (2.5 cm). An embodiment wherein the cutter head includes a single rotary cutting device may be about 1.1 inches (2.8 cm) in length, about 1.2 inches (3.0 cm) wide, and 1 inch (2.5 cm) in depth. The portion of the neck between the cutter head and the handle should have a cross section thinner than the cutter head and the handle, as shown in the figures. It is understood that while the present invention is not limited to the above identified dimensions, the cutter head can and should be configured to have a thinner width and depth than that of the handle.

The razor itself may be made from materials such as plastic, stainless steel or a ceramic material. The neck can be manufactured with different colors for personalization, or to identify neck and cutter heads of a particular configuration.

The cutting system positioned within the permanent cutter head is disposable, for replacement after multiple uses. In the embodiment of FIG. 3C, instead of one disposable rotary cutting system, there are two disposable rotary cutting systems 4 mounted in the permanent cutter head 8. These cutting systems are positioned next to each other, such that a line through the center of the cutting systems would run generally parallel to the axis or length of the handle and neck. This configuration provides a larger shaving area in a narrower footprint than traditional razors with cutting surfaces perpendicular to the length of the device. The permanent cutter head 8 may comprise disposable rotary cutting systems that are mounted so as to permit some flexibility or movement to better enable them to follow the curve of the body and move independently for a closer, more comfortable shave.

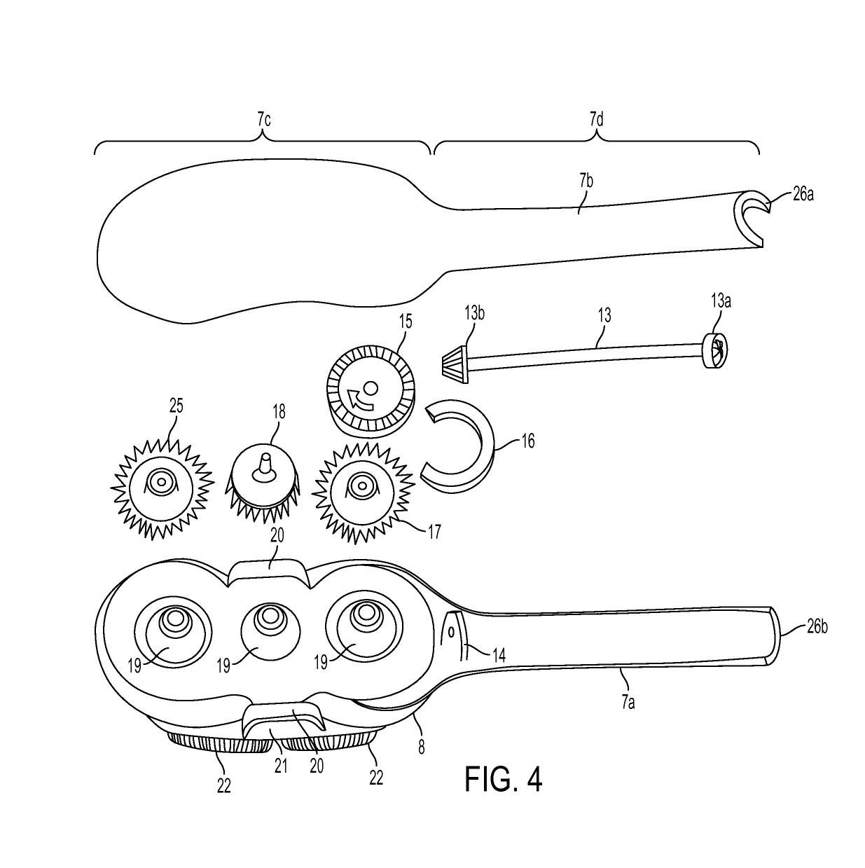

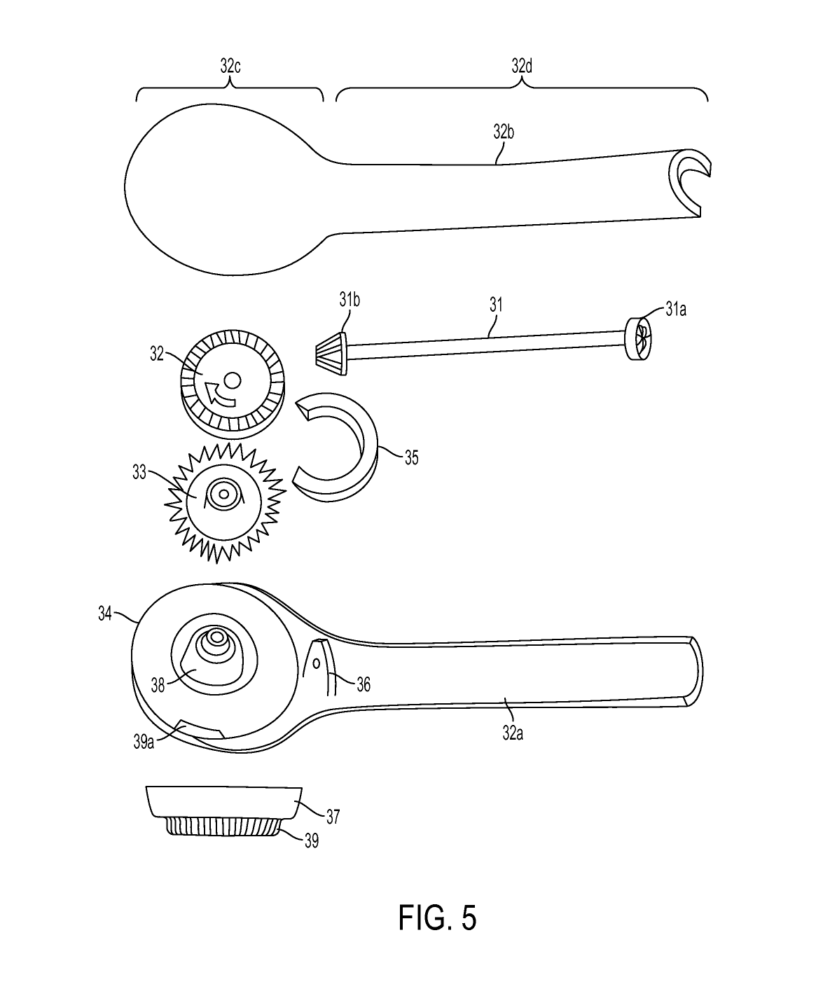

FIG. 4 shows an exploded view of the neck and cutter head according to an embodiment that includes two disposable rotary cutting systems, while FIG. 5 shows an exploded view of the neck and cutter head according to an embodiment that includes a single disposable rotary cutting system. As shown in FIG. 4, the neck is made of two components, 7a and 7b, which are releasably attached to the handle at end 26. In the alternative, the neck may be permanently attached to the handle. The back of the neck 7b shows that the neck has a smaller cross-section at the end that attaches to the handle 26a than the portion of the neck where the cutter head is located. When assembled, the front of the neck 7a is attached to the back of the neck 7b. The cutter head is permanently formed as part of the face of the upper portion of the front of the neck 7a. The cutter head shown in this embodiment includes two disposable rotary cutting systems 22.

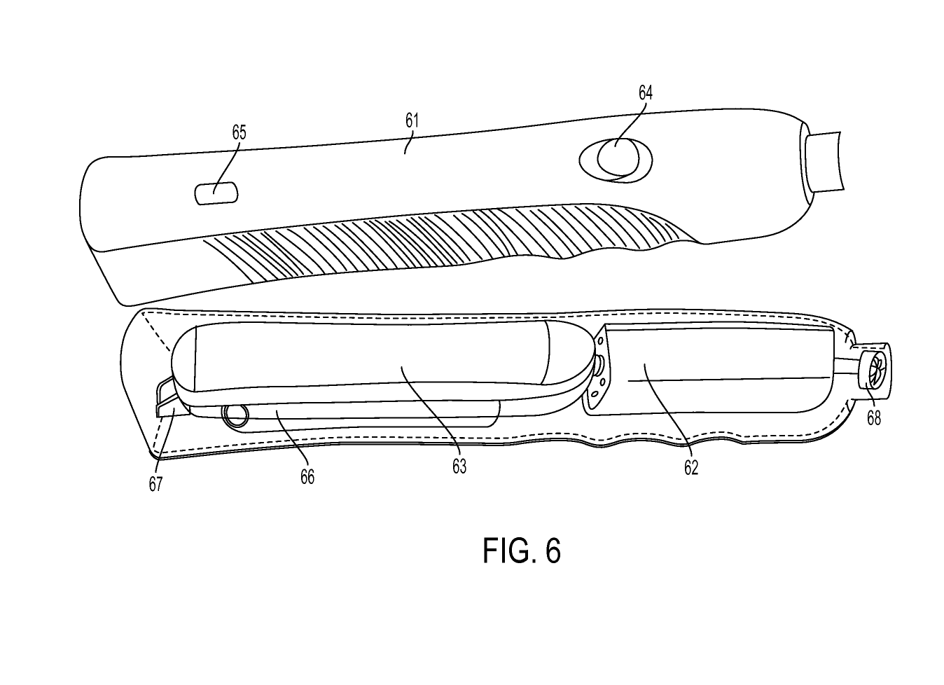

As shown in FIG. 6, the handle 61 contains a motor 62, a battery 66, a circuit board 63, a motor 62, an on/off power switch 64, and a battery indicator 65. The battery may be charged via ac charging plug 67 located, for example, in the base of the handle. The connection between motor and the rotary cutting system(s) is achieved by mechanical components that drive the cutting elements in the rotary cutting systems within the cutter head. For example, an AC power source or batteries drive a motor in the handle, which in turn drives a shaft that runs through the neck to the cutter head via a motor to neck drive shaft connector 68. The gears in the cutter head transfer the rotary force from the shaft to the cutting elements in the rotary cutting system(s).

As shown in FIG. 4, when assembled the lower end of the neck 7d houses the drive shaft 13, a drive shaft connector 13a which meshes with the motor to shaft drive connector 68, and pinion drive gear 13b, while the upper end of the neck 7c forms the cutter head and houses gears 15, 17, 18, 25. Pinion gear holder 14 ensures that the pinion gear is held in the correct position. Gears 15 and 17 are held in place with support ring 16. Cutting system holder 21 secures the rotating cutting systems 22 and rotary cutting elements (not shown) to cutter head gear supports 19 where the rotating cutting elements can be driven by gears 15, 17, 18, and 25. Cutter head 8 also comprises cutting system holder release buttons 20 which permit the cutting system holder 21 and rotary cutting systems 22 to be released from the cutter head. Similarly, in the single cutting system embodiment of FIG. 5, the neck is formed from front and back components 32a and 32b. When assembled, the lower end of the neck 32d houses drive shaft 31, drive shaft connector 31 a which meshes with the motor to shaft drive connector 68, and a pinion drive gear 31b, while the upper end of neck 32c forms the cutter head and houses gears 32, 33. Pinion gear holder 36 ensures that the pinion gear is held in the correct position. Gears 32 and 33 are held in place with support ring 35. Cutting system holder 37 secures the rotary cutting system 39 and rotary cutting elements to head gear support 38, where the cutting elements can be driven by gears 32, 33. Cutter head 34 also comprises cutting system holder release button 39a which permit the cutting system holder 37 and rotary cutting system 39 to be released from the cutter head. As will be appreciated, the configurations shown in FIGS. 4 and 5 include a cutter head containing cuttings systems with cutting elements that can be replaced.

The embodiment of FIG. 7 includes two disposable rotary cutting systems 71, in permanent cutter head 72 on neck 736, which is attached to handle at an angle. The razor shown in this figure also includes an on/off switch 75 and a battery indicator 76.

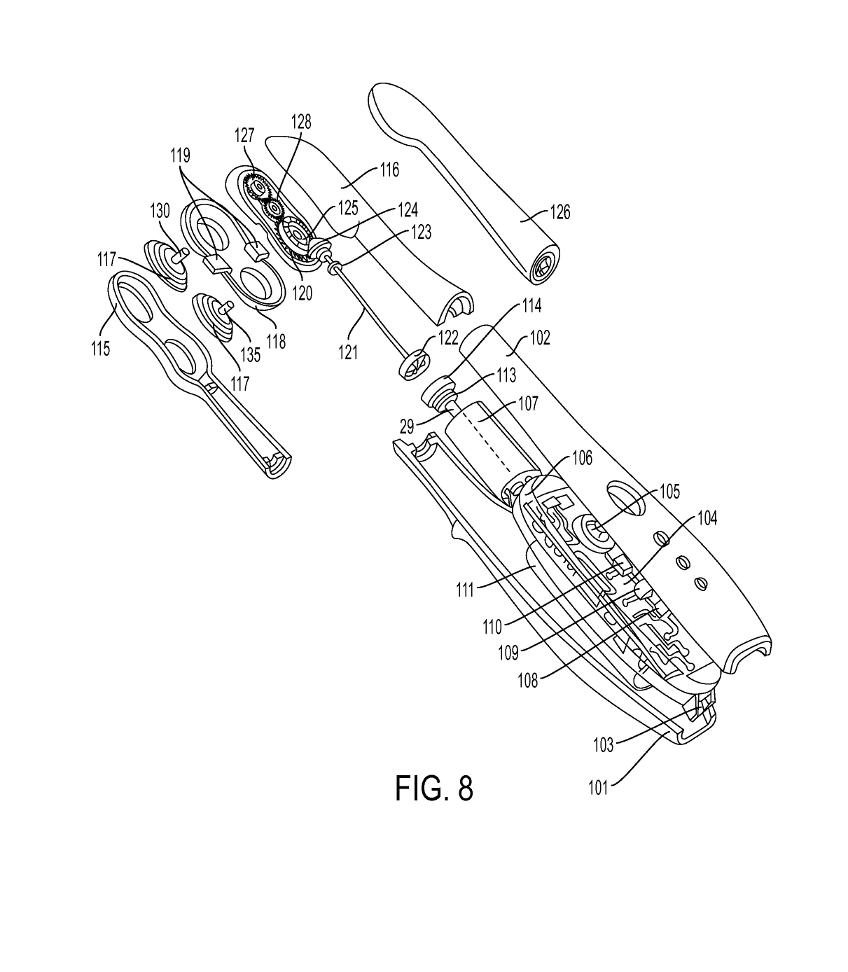

FIG. 8 shows an exploded view of another embodiment of the razor. This embodiment includes handle bottom cover 101 and a handle top cover 102, which may be snapped or sealed together by any conventional means so as to enclose the interior components of the handle. The interior components comprise charging port 103, circuit board 104, on/off button cover 105, electronics waterproof cover 106, and motor 107. The circuit board 104 comprises low battery indicator LED 108, charge status indicator LED 109, and on-off indicator LED 110. The handle also includes two rechargeable batteries 111. The motor has a rubber, waterproof seal 113 and a handle to neck shaft connector 114. In this embodiment, the handle is connected by conventional means to the neck. The neck has an outer neck bottom cover 115, and neck bottom cover 116, which are snapped and/or sealed together by conventional means. The interior of the tip of the neck houses cutting elements 117, cover 118, cover release buttons 119, gear frame 120 and neck drive shaft 121. The neck drive shaft has a neck to handle shaft connector 122 which interfaces with handle to neck shaft connector 114. The neck drive shaft also has a pinion gear shaft bearing 123 and a shaft drive pinion gear 124. The shaft drive pinion gear interfaces with the main razor pinion gear 125, which in turn interfaces with the other gears 127 and 128 to drive the rotary cutting elements via shafts 130, 135. An assembled single rotary cutting system neck 126 is also shown. One of ordinary skill will understand that when the motor in the handle is switched on it causes the neck drive shaft to rotate; this rotates the shaft drive pinion gear, which in turn causes the main razor gear to rotate; this rotates the smaller gear 128 and larger gear 127, causing rotation of the rotary cutting elements 117. This configuration is also waterproof.

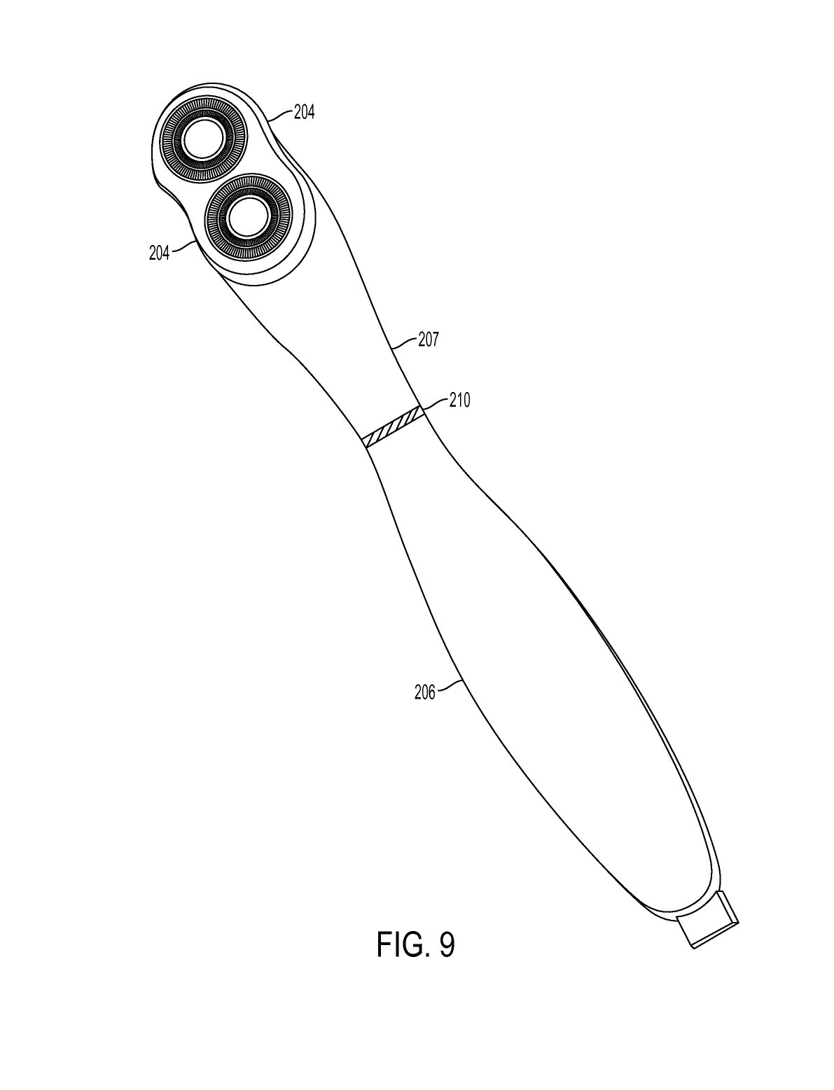

FIG. 9 shows an alternative embodiment of the razor device with two disposable rotary cutting systems 204 mounted on the permanent cutter head. This embodiment includes handle 206 having a thinner neck 207. The neck is detachable from the handle at 210.

The foregoing descriptions of specific embodiments of the present invention have been presented for purposes of illustration and description. They are not intended to be exhaustive or to limit the invention and method of use to the precise forms disclosed. Obviously many modifications and variations are possible in light of the above teachings. It is understood that various omissions or substitutions of equivalents are contemplated as circumstance may suggest or render expedient, but is intended to cover the application or implementation without departing from the spirit or scope of the claims of the present invention.

What is claimed is:

1. A razor device configured to shave the inner buttocks of a person's body, comprising:
a handle of substantially cylindrical shape and containing a drive motor;
a neck of substantially cylindrical shape, having two end regions and a middle region, the first end region including means for attachment of the neck to the handle, the second end region forming a cutter head including at least one rotary cutting system therein such that the rotary cutting system is positioned along the second end region on the substantially cylindrical surface and not on the top end of the neck, and the middle region having a cross-section smaller than that of the handle;
drive means positioned between the drive motor and the rotary cutting system to transfer rotational force from the motor to cutting elements in the rotary cutting system when the device is operated;
wherein the cutting head is configured to enable a user to shave the region of the inner buttocks.

2. The razor device according to claim 1 wherein said cutting head includes one rotary cutting system having a plurality of cutting elements.

3. The razor device according to claim 1 wherein said cutting head includes two rotary cutting systems, each having a plurality of cutting elements.

4. The razor device of claim 1 wherein the cutting head has a width that is less than about 1.5 times the diameter of a rotary cutting system.

5. The razor device of claim 1 wherein the cutting head has a length that is less than about 1.5 times the sum of the diameters of all rotary cutting systems on the head.

6. The razor device according to claim 1 wherein said neck may be detached from the handle by the user and replaced with an alternate neck having a cutting head with a different configuration than the original cutting head.

7. The razor device according to claim 6 wherein said neck may be detached from the handle by the user and replaced with an alternate neck having a cutting head containing a different number of rotary cutting systems than the cutting head of the original neck.

8. The razor device according to claim I wherein said neck may be detached from the handle by the user and replaced with an alternate neck that includes a curved portion.

9. The razor device according to claim 1 wherein said neck may be detached from the handle by the user and replaced with an alternate neck that, when attached to the handle, forms an angle to the length of the handle.

10. The razor device according to claim 1 wherein said cutting head further comprises a detachable holder and changeable cutting elements that enable the user to replace the rotary cutting system.

11. The razor device according to claim 1 wherein said razor device includes a battery charge indicator.

12. The razor device according to claim 1 wherein said neck is disposable and designed for single use.

13. The razor device according to claim 1 wherein said neck is formed as a permanent part of the handle.

14. A method for hygienically shaving the inner buttocks of a person, comprising the steps of
providing a razor device comprising a handle containing a drive motor, a neck having a portion with a cross-section smaller than that of the handle and including two end regions, the first end region for attachment of the neck to the handle and the second end region comprising a narrow cutter head portion including at least one disposable rotary cutting system positioned therein along the side wall of the neck, drive means positioned between the motor and the rotary cutting system to cause rotary cutting elements in the rotary cutting system to rotate when the device is operated;
selecting a neck and a cutter head configuration suitable for the person to be shaved;
installing the selected neck and cutter head configuration by attaching the neck to the handle;
positioning the narrow cutter head portion within the gluteal cleft;
activating the motor in the handle to drive rotary cutting elements of the cutting system in the cutting head;
shaving the hair within the gluteal cleft by moving the razor handle to move the narrow cutter head portion containing the activated rotary cutting elements within the gluteal cleft;
disposing the used neck and cutter head after use.
